(19) United States
(12) Patent Application Publication
(10) Pub. No.: US 2026/0192614 A1
(43) Pub. Date: Jul. 9, 2026

(54) TIRE ELECTRONICS ASSEMBLY

(71) Applicant: Bridgestone Americas Tire Operations, LLC, Nashville, TN (US)

(72) Inventors: Kevin E. Scheifele, Atwater, OH (US); Hans R. Dorfi, Akron, OH (US)

(21) Appl. No.: 19/552,870

(22) Filed: Feb. 27, 2026

Related U.S. Application Data
(62) Division of application No. 17/631,884, filed on Jul. 28, 2020, now abandoned.
(60) Provisional application No. 62/882,790, filed on Aug. 5, 2019.

(51) Int. Cl. B60C 23/04; B60C 19/00

(52) U.S. Cl. CPC B60C 23/0493; B60C 19/00; B60C 2019/004

(57) ABSTRACT

An electronics assembly includes a base and a plurality of modules. The base is configured for mechanical attachment to a tire. The base includes an electronic device, and also includes a mechanical attachment element. Each module includes an electronic device, a lower mechanical attachment element, and an upper mechanical attachment element. The lower mechanical attachment element on each one of the modules is configured for attachment to the upper mechanical attachment element on any other one of the modules. In this configuration, the modules are interchangeably mechanically attachable to each other in a stacked arrangement. Each lower mechanical attachment element is also configured for attachment to the mechanical attachment element on the base. The modules are thus mechanically attachable to the base interchangeably with each other, which enables any one of the modules to be installed as the lowermost module in the stacked arrangement.

### FIELD OF THE INVENTION

This technology includes electronic devices for sensing conditions of a tire on a vehicle.

### BACKGROUND

Electronic devices can be used to sense conditions of a tire on a vehicle. Such devices include air pressure and temperature sensors that are mounted inside the tire, and also include radio frequency transmitters for transmitting pressure and temperature signals from the tire to the vehicle.

### SUMMARY

An electronics assembly is provided for use with a tire. In a given example, the assembly includes a base and a plurality of modules. The base is configured for mechanical attachment to the tire and includes an electronic device. The base also includes a mechanical attachment element. Each module includes an electronic device, a lower mechanical attachment element, and an upper mechanical attachment element.

The lower mechanical attachment element on each one of the modules is configured to attach to the upper mechanical attachment element on any other one of the modules. In this configuration, the modules are interchangeably mechanically attachable to each other in a stacked arrangement.

The lower mechanical attachment element on each one of the modules is also configured to attach to the mechanical attachment element on the base. The modules are thus mechanically attachable to the base interchangeably with each other, which enables any one of the modules to be installed as the lowermost module in the stacked arrangement.

Additionally, a lower electrical contact on each one of the modules is configured to electrically connect with an upper electrical contact on any other one of the modules. In this configuration, the modules are interchangeably electrically connectable with each other in the stacked arrangement. The lower electrical contact on each one of the modules is further configured to connect electrically with an electrical contact on the base, whereby the modules are interchangeably electrically connectable with the base as the lowermost module in the stacked arrangement.

In an illustrated embodiment, the base is configured to overlie an interior surface of the tire. Another illustrated embodiment includes a base configured for embedded installation within the tire. In yet another embodiment the base is configured for installation between layers of the tire.

### BRIEF DESCRIPTION OF THE DRAWINGS

FIG. 1 is a schematic sectional view of a tire and an electronics assembly for use with the tire.

FIG. 2 is an exploded view of parts of the electronic assembly of FIG. 1.

FIG. 3 is a schematic sectional view of an alternative embodiment of a tire and an electronics assembly for use with the tire.

FIG. 4 is a schematic sectional view of alternative embodiment of a tire and an electronics assembly for use with the tire.

FIG. 5 is a schematic sectional view of an alternative embodiment of a tire and an electronics assembly for use with the tire.

FIG. 6 is a schematic sectional view of an alternative embodiment of a tire and an electronics assembly for use with the tire.

FIG. 7 is a schematic sectional view of an alternative embodiment of a tire and an electronics assembly for use with the tire.

### DETAILED DESCRIPTION

The structures illustrated in the drawings include examples of the elements recited in the claims. The illustrated structures thus include examples of how a person of ordinary skill in the art can make and use the claimed invention. They are described here to provide enablement and best mode without imposing limitations that are not recited in the claims. One or more elements of one embodiment may be used in combination with, or as a substitute for, one or more elements of another embodiment as needed for any particular implementation of the invention.

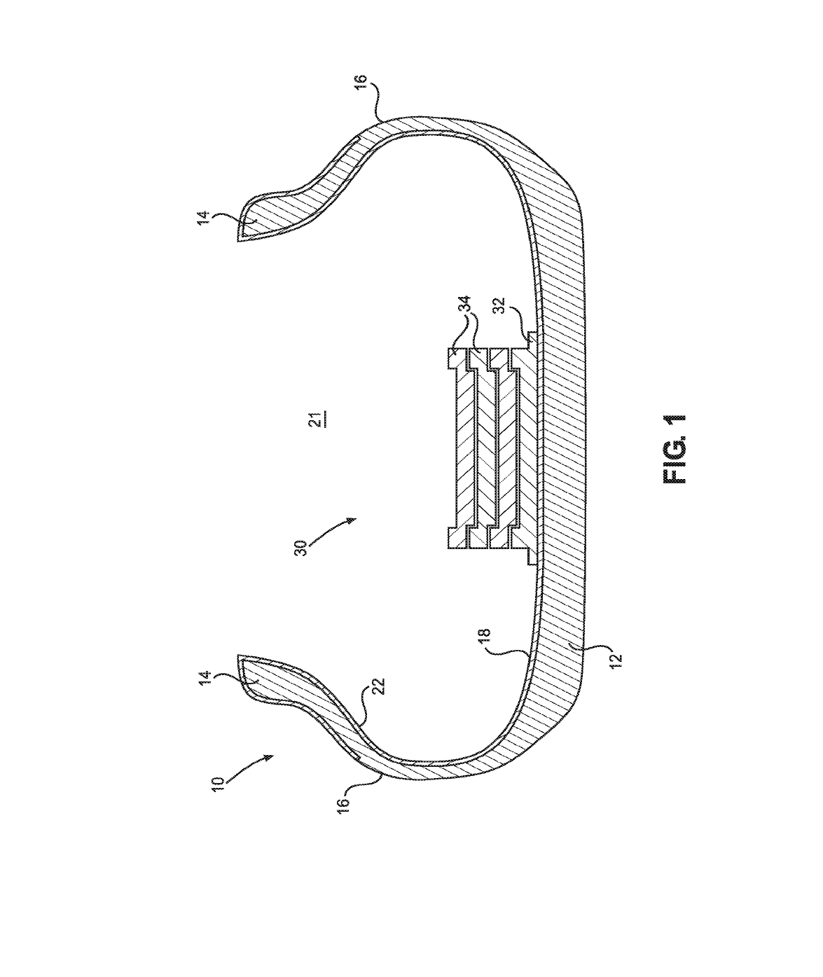

As shown in FIG. 1, a pneumatic tire 10 includes a tread 12, bead portions 14, and sidewalls 16 interconnecting the tread 12 with the bead portions 14. An inner surface 18 of the tire 10 defines the periphery of a cavity 21 within the tire 10. The inner surface 18 in this example is provided by an innerliner 22 that reaches fully throughout the interior of the tread 12, the bead portions 14, and the sidewalls 16.

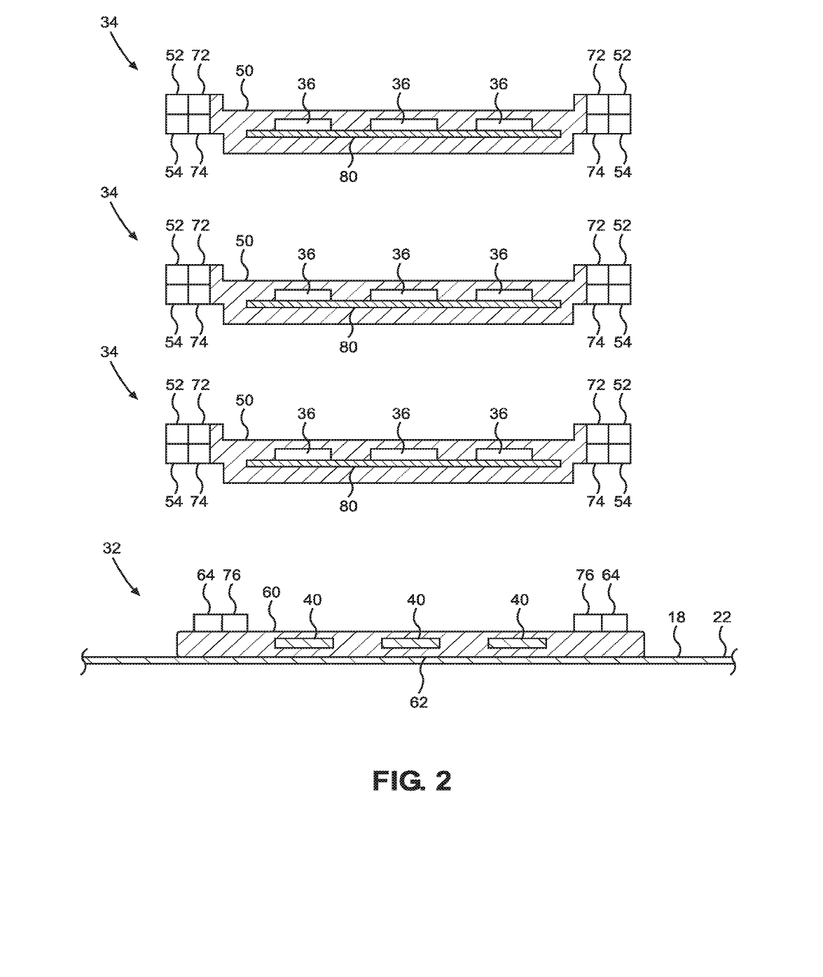

Also shown in FIG. 1 is an electronics assembly 30 for use with the tire 10. The electronics assembly 30 in this example includes a base 32 and multiple modules 34. As shown schematically in FIG. 2, each module 34 includes one or more electronic devices 36. The devices 36 in the modules 34 may include air pressure sensors, temperature sensors, power generation or storage devices, radio frequency transmitters, radio frequency receivers, and/or any other electronic devices suitable for obtaining and/or providing information relating to conditions of the tire 10.

The base 32 also includes one or more electronic devices 40 (FIG. 2). These may include an electronic device 40 configured to provide a unique identification signal for identifying the tire 10 in distinction from another tire on the same vehicle or a different vehicle. Other electronic devices 40 in the base 32 may be configured to receive and/or transmit signals between the devices 40 in the base, the devices 36 in the modules 34, and the vehicle. In each case, the electronic devices 36 and 40 may be configured in any suitable manner known in the art.

As shown separately in FIG. 2, each of the modules 34 of FIG. 1 includes a panel-shaped housing 50 containing the respective electronic devices 36. Upper mechanical attachment elements 52 face upward from each housing 50. Lower mechanical attachment elements 54 face downward from each housing 50. The lower mechanical attachment elements 54 on each one of the housings 50 are configured to releasably mechanically attach to the upper mechanical attachment elements 52 on any other one of the housings 50. Accordingly, the modules 34 are interchangeably mechanically attachable to each other in a stacked arrangement, as shown for example in FIG. 1. The mechanical attachment elements 52 and 54 shown schematically in the drawings can be configured to accomplish the releasable attachments in any suitable manner known in the art of interconnecting modular structures.

The base 32 of the electronics assembly 30 is attached to the tire 10 at the interior of the tire 10. As shown schematically in FIG. 2, the base 32 includes a panel-shaped housing 60 containing the electronic devices 40. The housing 60 has a lower side surface 62 adhered to the inner surface 18 of the tire 10. Mechanical attachment elements 64 face upward from the housing 60. The lower mechanical attachment elements 54 on any one of the modules 34 can releasably mechanically attach to the mechanical attachment elements 64 on the base 32. This enables any one of the modules 34 to be installed as the lowermost module 34 in the stack shown in FIG. 1.

In addition to the mechanical attachment elements 52 and 54, each module 34 also has upper electrical contacts 72 facing upward from the housing 50, and lower electrical contacts 74 facing downward from the housing 50. The lower electrical contacts 74 on each one of the modules 34 are configured to releasably electrically connect with the upper electrical contacts 72 on any other one of the housings 50. This enables the modules 34 to be interchangeably electrically connectable with each other in the stack of FIG. 1. The electrical contacts 72 and 74 shown schematically in the drawings can be provided as pin and socket connectors that also function as the mechanical attachment elements 52 and 54 described above. In other embodiments the electrical contacts 72 and 74 can be configured to accomplish the releasable electrical connections in any suitable manner known in the art of electrical contacts.

The base 32 has electrical contacts 76 facing upward from the housing 60. Like the electrical contacts 72 and 74 on the modules 34, the electrical contacts 76 on the base 32 can include pin and socket connectors that double as the mechanical attachment elements 64. The lower electrical contacts 74 on any one of the module housings 50 can releasably electrically connect with the electrical contacts 76 on the base 32. Any one of the modules 34 can thus function as the lowermost module 34 in the stack of FIG. 1.

As further shown schematically in FIG. 2, the electrical devices 36 in the modules 34 are mounted on printed circuit boards 80. Each printed circuit board 80 is configured to electrically connect the devices 36 in the respective module 34 in series with the devices 36 in any other two of the modules 34. Each printed circuit board 80 is further configured to electrically connect the devices 36 in the respective module 34 in series with the devices 40 in the base 32.

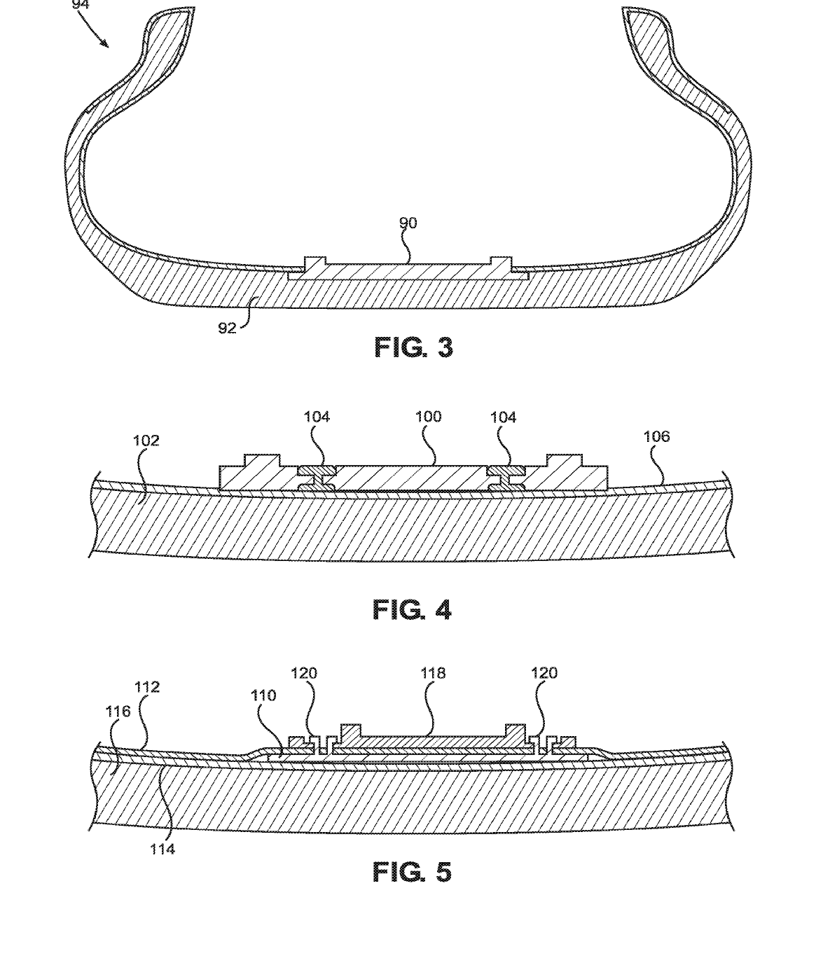

FIGS. 3-5 show alternative embodiments of a base for use with modules like the modules 34 of FIGS. 1 and 2. As shown in FIG. 3, a base 90 that is substantially the same as the base 32 is embedded within the body of the tire in the tread portion 92 of a tire 94. As shown in FIG. 4, a base 100 is attached to a tire 102 by fasteners 104 that are attached to an innerliner 106. As shown in FIG. 5, a support platform 110 is installed between layers 112 and 114 of a tire 116. The base 118 in this embodiment is mounted over the innermost layer 112 of the tire 116 and is retained in place by fasteners 120 projecting from the support platform 110 through the innermost layer 112.

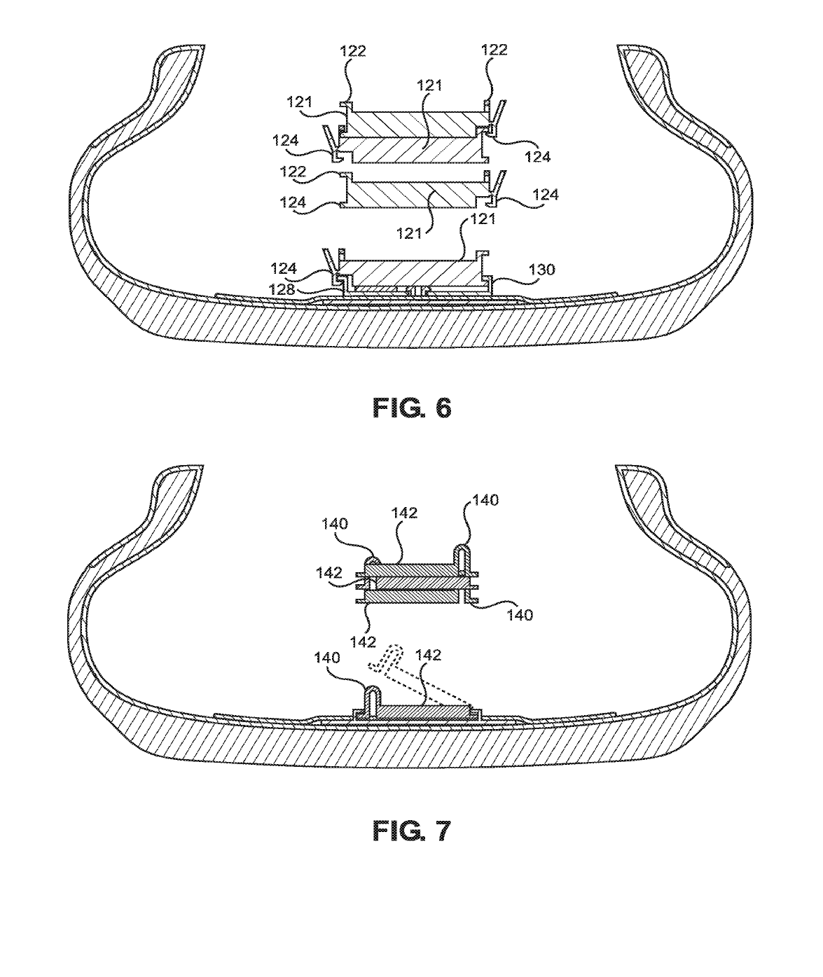

In the alternative embodiment of FIG. 6, the modules 121 have upper mechanical attachment elements 122 and lower attachment elements 124. One of the lower mechanical attachment elements 124 on each module 121 is configured as a flexible hook for snapping into releasable interlocked engagement with one of the upper mechanical attachment elements 122 on any other one of the modules 121. Those lower attachment elements 124 can likewise snap into engagement with complimentary attachment element 128 on a base structure 130. The embodiment of FIG. 7 also has flexible mechanical attachment elements 140 for each module 142 to snap into engagement with any other module 142 or with the base structure 144.

This written description sets for the best mode of carrying out the invention and describes the invention so as to enable a person of ordinary skill in the art to make and use the invention, by presenting examples of the elements recited in the claims. The detailed descriptions of those elements do not impose limitations that are not recited in the claims.

What is claimed is:

1-7. (canceled)

8. An apparatus for use with a tire, comprising:
a base configured for mechanical attachment to the tire, the base including an electronic device and having an electrical contact; and
a plurality of modules, each of which includes an electronic device, a lower electrical contact, and an upper electrical contact;
wherein the lower electrical contact on each one of the modules is configured to electrically connect with the upper electrical contact on any other one of the modules, whereby the modules are interchangeably electrically connectable with each other; and
the lower electrical contact on each one of the modules is configured to electrically connect with the electrical contact on the base, whereby the modules are interchangeably electrically connectable with the base.

9. An apparatus as defined in claim 8, wherein each one of the modules includes circuitry configured to electrically connect any other two of the modules in series with one another.

10. An apparatus as defined in claim 8, wherein each one of the modules includes circuitry configured to electrically connect any one of the modules in series with the base.

11. An apparatus as defined in claim 8, wherein the electronic device in the base is configured to provide a unique identification signal identifying the tire.

12. An apparatus as defined in claim 8, wherein the base is configured for embedded installation within the tire.

13. An apparatus as defined in claim 8, wherein the base is configured for installation between layers of the tire.

14. An apparatus, comprising:
a tire;
a base attached to the tire, the base including an electronic device and a mechanical attachment element; and
a plurality of modules, each of which includes an electronic device, a lower mechanical attachment element, and an upper mechanical attachment element;
wherein the lower mechanical attachment element on each one of the modules is configured to mechanically attach to the upper mechanical attachment element on any other one of the modules, whereby the modules are interchangeably mechanically attachable to each other; and
the lower mechanical attachment element on each one of the modules is configured to mechanically attach to the mechanical attachment element on the base, whereby the modules are interchangeably mechanically attachable to the base.

15. An apparatus as defined in claim 14, wherein the electronic device in the base is configured to provide a unique identification signal identifying the tire.

16. An apparatus as defined in claim 14, wherein the base is embedded within the tire.

17. An apparatus as defined in claim 14, wherein the base is installed between layers of the tire.

18. An apparatus as defined in claim 14, wherein the base further includes an electrical contact, each module includes a lower electrical contact, and each module further includes an upper electrical contact;
wherein the lower electrical contact on each one of the modules is configured to electrically connect with the upper electrical contact on any other one of the modules, whereby the modules are interchangeably electrically connectable with each other; and
the lower electrical contact on each one of the modules is configured to electrically connect with the electrical contact on the base, whereby the modules are interchangeably electrically connectable with the base.

19. An apparatus as defined in claim 18, wherein each one of the modules includes circuitry configured to electrically connect any other two of the modules in series with one another.

20. An apparatus as defined in claim 18, wherein each one of the modules includes circuitry configured to electrically connect any one of the modules in series with the base.
